(19) United States
(12) Patent Application Publication
(10) Pub. No.: US 2003/0012019 A1
(43) Pub. Date: Jan. 16, 2003

(54) Multi-color pipe-type lamp

(76) Inventor: Wen-Fang Pan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/904,526

(22) Filed: Jul. 16, 2001

(51) Int. Cl. F21V 9/00

(52) U.S. Cl. 362/231; 362/240

(57) ABSTRACT

The present invention relates to a multi-color pipe-type lamp, which includes an inner tube being provided with different color and then covered by an outer tube to become a multi-color lamp. The multi-color pipe-type lamp has a smooth surface and the color will not be dropped even a long time use or contact that obtains a utilized effect and improvement.

### BACKGROUND OF THE INVENTION

A conventional pipe-type lamp appears a single pipe with a mono color or a transparent outlook. It is without special decorative effect but lighting. A prior improvement is designed, as shown in FIG. 1, which has several color sections in a pipe-type lamp (1) to increase decoration. This known structure includes several short lamps (11), each of which is formed to be a specific color, to assemble together by pins (12) beside the short lamp (11) becoming a long pipe-type lamp with multi-color. This structure is inconvenient in manufacturing and assembling. The assembly is not secure and will be easily released in use. Another prior improved structure is shown in FIG. 2, which includes a long pipe-type lamp (2) to be directly sprayed paint with different color in different section of the lamp. It is although convenient in manufacturing. But coated paint outside the lamp is rough and would be dropped that causes an ugly outlook.

Accordingly, the primary object of the invention is to provide a novel multi-color pipe-type lamp having different color on the lamp and keeping the colors in stable while the surface of the lamp will be smooth. Now the features and advantages of the present invention will be described in detail with reference to the accompanying drawings.

### BRIEF DESCRIPTION OF ACCOMPANYING DRAWINGS

FIG. 1 is an exploded perspective view showing a prior pipe-type lamp.

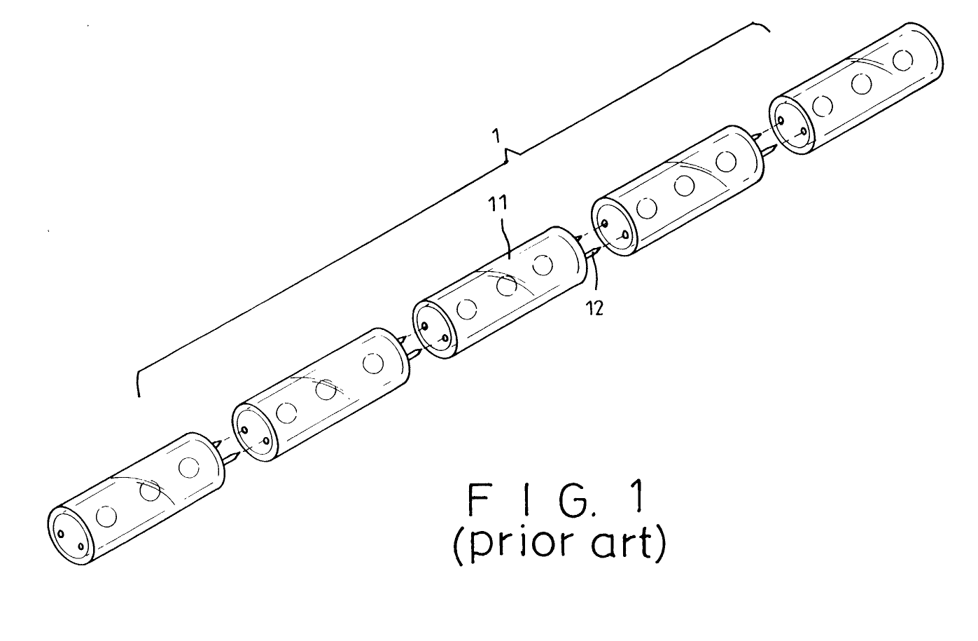

FIG. 2 is a perspective view showing another prior pipe-type lamp.

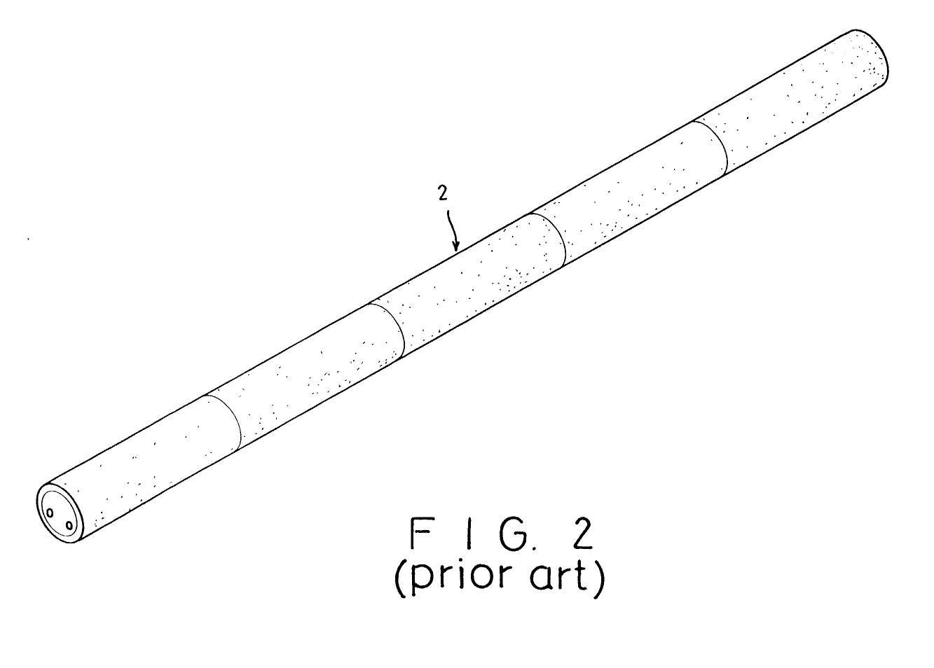

FIG. 3 is a perspective view showing a multi-color pipe-type lamp according to the present invention.

### DETAILED DESCRIPTION OF PREFERRED EMBODIMENTS

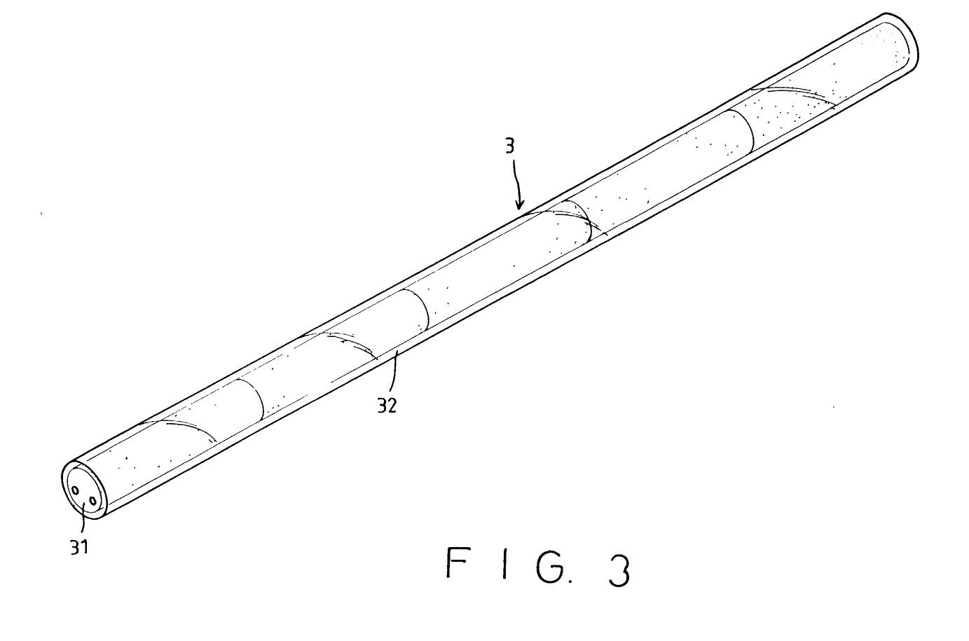

Please refer to FIG. 3, the present invention relates to an improvement of a multi-color pipe-type lamp (3). It is known that a pipe-type lamp (3) includes an inner tube (31) and an outer tube (32). The characteristic of the present invention is to provide different colors on different sections of the inner tube (31). The inner tube (31) can be directly sprayed paint or coated with color films. The outer tube (32) is then covered around the inner tube (31) to form a novel multi-color pipe-type lamp based on this invention.

Under the assembled structure as aforesaid, due to the color layer is under the outer tube (32), the lamp (3) keeps a perfect smooth surface. Moreover, the color on the lamp (3) will not be dropped during a long time use or any direct contact. It is to be understood that the improvement of the invention provides a novel utility and overcomes the drawback of any prior one.

Accordingly, the present invention obviously gains the utility and novelty for patent and is thus applied.

What is claimed is:

1. A multi-color pipe-type lamp including an inner tube and an outer tube, wherein the inner tube is provided with different colors at different sections and then be covered by the outer tube to become a pipe-type lamp with multi-color layer between the inner tube and the outer tube.

2. The multi-color pipe-type lamp as claimed in claim 1, wherein the inner tube is directly sprayed paint or coated with color films.
